(19) United States
(12) Patent Application Publication
(10) Pub. No.: US 2026/0109527 A1
(43) Pub. Date: Apr. 23, 2026

(54) VACUUM SEALABLE CONTAINER

(71) Applicant: Honeybee Robotics, LLC, Longmont, CO (US)

(72) Inventors: Leo Stolov, Pasadena, CA (US); Maria Fountas, Pasadena, CA (US); Philip Chu, Manvel, TX (US); Kris Zacny, Altadena, CA (US)

(21) Appl. No.: 19/373,863

(22) Filed: Oct. 30, 2025

Related U.S. Application Data
(62) Division of application No. 19/328,435, filed on Sep. 15, 2025.
(60) Provisional application No. 63/694,426, filed on Sep. 13, 2024.
(60) Provisional application No. 63/694,415, filed on Sep. 13, 2024.

(51) Int. Cl. B65D 81/20; B65D 53/02

(52) U.S. Cl. CPC B65D 81/2015; B65D 53/02

(57) ABSTRACT

A vacuum sealable container for securing and transporting extraterrestrial samples includes a container body and a lid assembly detachably coupled to the container body, the lid assembly selectively hermetically sealing the container body. The lid assembly includes an input shaft configured to receive a rotational input; a worm gear assembly connected to the input shaft; an output shaft coupled to the worm gear assembly. The worm gear assembly moves a claw member along an axial direction with respect to the lid assembly.

### CROSS-REFERENCE TO RELATED APPLICATIONS

This application is a Divisional of U.S. patent application Ser. No. 19/328,435, filed on Sep. 15, 2025, which claims the benefit of U.S. Provisional Ser. No. 63/694,415 , filed on Sep. 13, 2024 and U.S. Provisional Ser. No. 63/694,426 , filed on Sep. 13, 2024. The entire contents of the aforementioned application is incorporated herein by reference.

### BACKGROUND

The subject matter disclosed herein relates in general to a vacuum sealable container for transporting an extraterrestrial sample.

Conventional vacuum sealable containers have been designed for robotic missions. A manually operable vacuum sealable container was employed in the Apollo missions with limited capabilities. For example, the container employed in the Apollo missions did not include a mechanism for extracting gas from the container after it was returned to Earth.

Accordingly, while existing vacuum sealable containers are suitable for their intended purposes the need for improvement remains, particularly in providing a vacuum sealable container having the features described herein.

### BRIEF DESCRIPTION

According to one aspect of the disclosure, a vacuum sealable container is provided. The vacuum sealable container may include a container body and a lid assembly detachably coupled to the container body. The lid assembly may include an input shaft extending along a first direction perpendicular to the axial direction and configured to receive a rotational input, an output shaft extending along a second direction parallel with the axial direction and coupled to the input shaft, and a handle member coupled to the input shaft, the handle member configured to impart a rotational force to the input shaft. The vacuum sealable container may further include a worm shaft connected at the input shaft; a shaft gear provided at the output shaft, the shaft gear being in geared connection with the worm shaft; a worm gearbox operably connected between the input shaft and the worm shaft, the worm gearbox configured to provide a gear reduction between the input shaft and the worm shaft; and a claw member threadedly coupled with the output shaft. The claw member may be configured to translate along the axial direction in response to a rotation of the output shaft.

According to another aspect of the present disclosure, a vacuum sealable container is provided. The vacuum sealable container may include a container body and a lid assembly detachably coupled to the container body. The lid assembly may include an input shaft extending along a first direction perpendicular to the axial direction and configured to receive a rotational input, an output shaft extending along a second direction parallel with the axial direction and coupled to the input shaft, and a handle member coupled to the input shaft, the handle member configured to impart a rotational force to the input shaft. The vacuum sealable container may further include a worm shaft connected at the input shaft; and a shaft gear provided at the output shaft, the shaft gear being in geared connection with the worm shaft.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a vacuum sealable container in accordance with an embodiment;

FIG. 2 is a sectional perspective view of the top and bottom portions of a vacuum sealable container in accordance with an embodiment;

FIG. 3A is a perspective sectional view of a container body in accordance with an embodiment;

FIG. 3B is an enlarged sectional view of a top portion of a container body in accordance with an embodiment;

FIG. 4 is a sectional perspective view of a lid assembly for a vacuum sealable container in accordance with an embodiment;

FIG. 5 is sectional view of a lid assembly in accordance with an embodiment;

FIG. 6A is a perspective view of a lid assembly in accordance with an embodiment;

FIG. 6B is an alternative perspective view of the lid assembly of FIG. 6A in accordance with an embodiment;

FIG. 7 is a side sectional view of a vacuum sealable container in accordance with an embodiment; and

FIG. 8 is another sectional view of a sample tube for use with the vacuum sealable container according to an embodiment of the present disclosure.

FIG. 9 is a perspective view of a lid assembly of a vacuum sealable container according to another embodiment of the present disclosure.

FIG. 10A is a perspective view of the exemplary lid assembly of FIG. 9 showing a handle assembly.

FIG. 10B is a top schematic view of a harmonic drive assembly according to exemplary embodiments of the present disclosure.

FIG. 11 is a perspective view of a vacuum sealable container according to another embodiment of the present disclosure.

FIG. 12 is a side sectional view of the exemplary lid assembly of FIG. 9.

FIG. 13 is a perspective view of the exemplary vacuum sealable container of FIG. 11 showing a bracket.

FIG. 14 is a perspective schematic view of an interior of a container body of a vacuum sealable container according to another embodiment of the present disclosure.

FIG. 15 is a perspective schematic view of an interior of a container body of a vacuum sealable container according to another embodiment of the present disclosure.

FIG. 16 is a top schematic view of an interior of a container body of a vacuum sealable container according to another embodiment of the present disclosure.

FIG. 17 is a top schematic view of an interior of a container body of a vacuum sealable container according to another embodiment of the present disclosure.

FIG. 18 is a perspective view of a lid assembly including a worm gear according to another exemplary embodiment of the present disclosure.

FIG. 19 is a perspective view of a container body and lid assembly including a bolt pattern according to another exemplary embodiment of the present disclosure.

FIG. 20 is a perspective view of a container body and lid assembly including a cam lock according to another exemplary embodiment of the present disclosure.

FIG. 21 is a perspective view of a container body and lid assembly including a C-clamp according to another exemplary embodiment of the present disclosure.

FIG. 22 is a perspective view of a container body including a flange clamp according to another exemplary embodiment of the present disclosure.

FIG. 23 is a perspective view of a lid assembly including a plunger assembly according to another exemplary embodiment of the present disclosure.

FIG. 24 is a perspective view of a container body including a threaded lid according to another exemplary embodiment of the present disclosure.

### DETAILED DESCRIPTION

During the Apollo moon landing missions a vacuum sealable container was used to store samples of materials acquired by the astronauts. One disadvantage of this container was the lack of consideration for preventing leaking of volatile samples. Soil samples or core samples, such as regolith, obtained from extraterrestrial environments often contain entrained gasses within the sample. As the container is transported between different environments at different ambient temperatures and pressures, this entrained gas may be released from the sample. As the number of scientific and commercial extraterrestrial endeavors increases, containers are needed that provide additional protective capabilities and account for attributes such as, but not limited to the release of entrained gases and dexterity of operators wearing bulky gloves.

Embodiments of the present disclosure reduce the risk of contamination of the contained sample and seal against internal pressure created by the volatilization of entrained gases that may occur as the temperature of a lunar sample increases. Further embodiments of the present disclosure provide a two-way seal that prevents volatiles under pressure from escaping from the container and prevents atmospheric air from infiltrating the sealed container upon moving the container into a pressurized environment, whether on the Moon, Earth, or another extraterrestrial body for example.

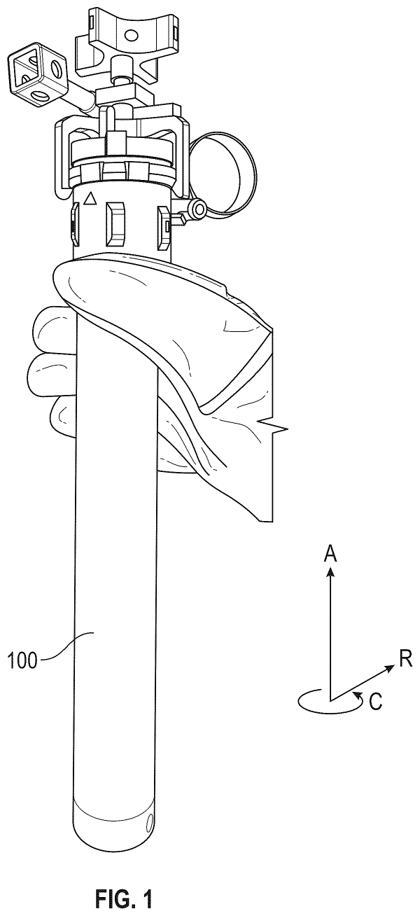

Referring now to FIG. 1, an embodiment is shown of a vacuum sealable container 100. It should be appreciated that while embodiments herein may refer to the use of vacuum sealable container 100 with respect to a particular application, such as collection of a sample from an extraterrestrial location, such as the Moon or its lunar surface, this is for example purposes and the claims should not be so limited. In other embodiments, the vacuum sealable container 100 described herein may be used in connection with sample collection from other terrestrial or extraterrestrial bodies, such as but not limited to Mars, asteroids, Kuiper Belt objects, and Trans-Neptunian objects for example. In still further embodiments, vacuum sealable container 100 may be used on moons/satellite objects of other solar system planets, such as Titan or Europa for example.

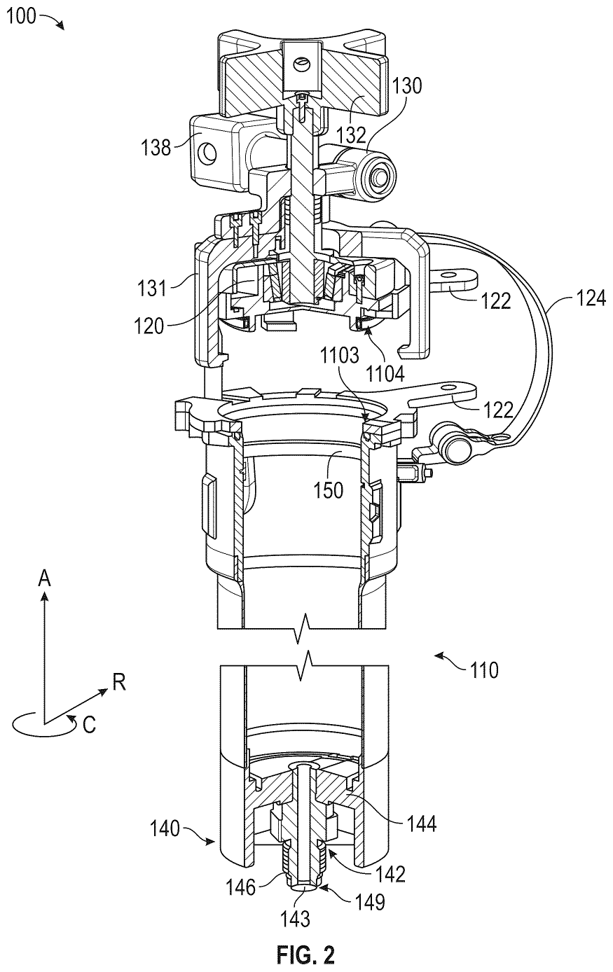

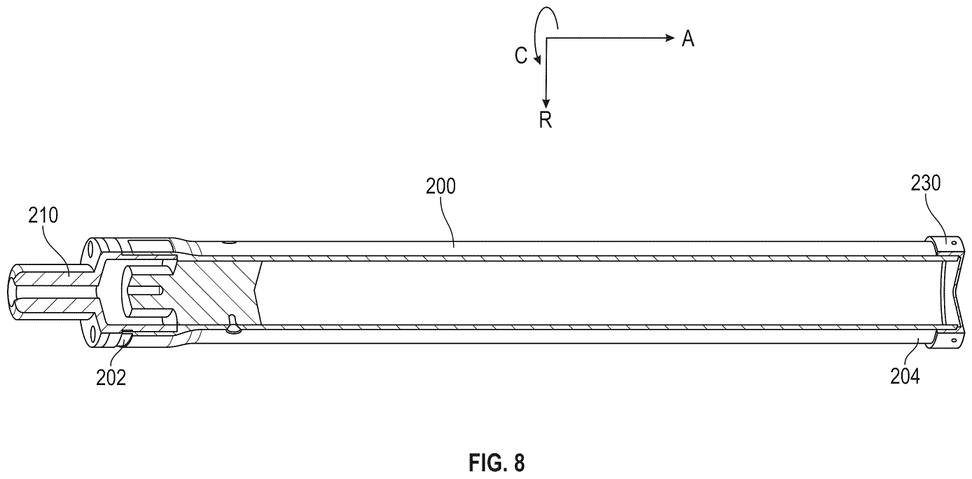

Referring to FIG. 2, with continuing reference to FIG. 1, an embodiment is shown of the top and bottom portions of vacuum sealable container 100. Vacuum sealable container 100 may include a container body 110 configured to secure a sample. Exemplary samples include soil, regolith, minerals, fossils, and the like. Container body 110 may be composed of a metal, for example aluminum or a stainless steel. It should be appreciated that while embodiments described herein and the figures describe and depict a cylindrical container, one of skill the art will recognize that the shape of container body 110 may vary in size and shape without deviating from the teachings provided herein. In some embodiments, container body 110 may receive a drive tube 200 (FIG. 8) containing the sample.

Container body 100 may further include a lid assembly 120 connectable to container body 110. Lid assembly 120 may be configured to selectively form a hermetic two-way seal between container body 110 and lid assembly 120. Container 100 may further include a locking mechanism 130 situated on or at an end of lid assembly 120 opposite container body 110. Locking mechanism 130 may be configured to secure lid assembly 120 to container body 110, locking the seal between container body 110 and lid assembly 120 in place.

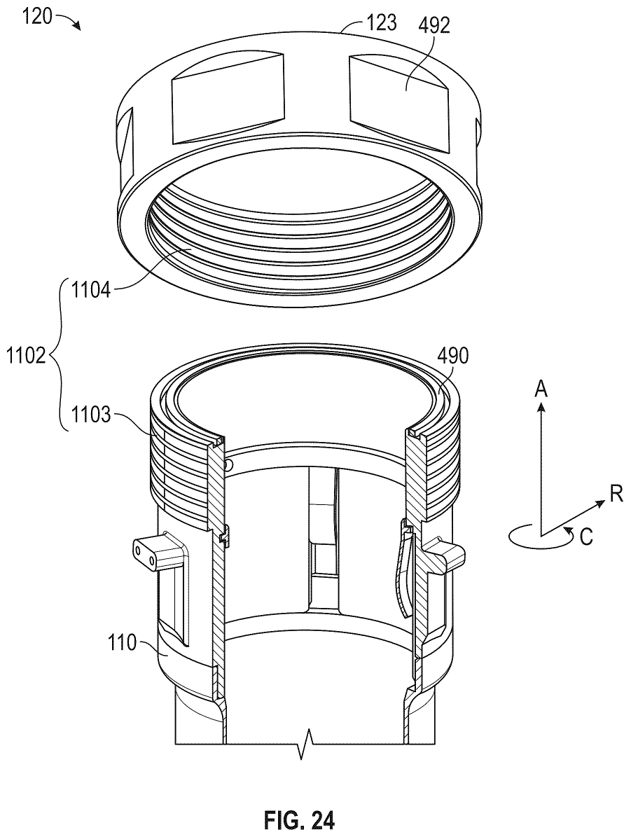

Referring briefly to FIG. 24, lid assembly 120 may be threadedly coupled (e.g., selectively) to container body 110 (see, e.g., FIG. 2). For example, lid assembly 120 may be selectively screwed onto container body 110 at a threaded connection 1102. Threaded connection 1102 may include a first threaded portion 1103 and a second threaded portion 1104. For instance, container body 110 may include first threaded portion 1103 while lid assembly 120 include second threaded portion 1104. In some instances, cap member 123 is provided a single lid piece (e.g., including second threaded portion 1104). Additionally or alternatively, a compressible O-ring 490 may be positioned at one of container body 110 or cap member 123. Additionally or alternatively, cap member 123 may include one or more indents 492 formed into an outer circumferential surface thereof. The one or more indents 492 may aid or assist a user (e.g., astronaut) in tightening the threaded cap member 123. to container body 110.

First threaded portion 1103 (and/or second threaded portion 1104) may include a thread having predetermined thread dimensions. For instance, the thread may define a thread diameter and a thread pitch. According to at least some embodiments, a ratio between the thread diameter and the thread pitch may be relatively high. For one example, the ratio between the thread diameter and the thread pitch is between about 60 and about 80. Advantageously, a user (e.g., astronaut) may achieve a higher sealing force between container body 110 and lid assembly 120 through a hand turn of lid assembly into a locked or closed position.

First threaded portion 1103 may be or include an external thread. For instance, a portion of an external surface of container body 110 may include first threaded portion 1103. As such, a thread may protrude outward along the radial direction R from the external surface of container body. Likewise, second threaded portion 1104 may be or include an internal thread. It should be understood that the specific threaded portions may be interchanged, such that first threaded portion 1103 is an internal thread and second threaded portion 1104 is an external thread, and the disclosure is not limited to the examples provided herein.

Container body 110 may define a top surface 1101. Top surface 1101 may face the axial direction A (e.g., have a surface normal towards lid assembly 120). As would be expected, top surface 1101 may define a top of container body with which lid assembly 120 may selectively mate. A groove 111 may be formed into top surface 1101. For instance, groove 111 may be recessed into top surface 1101 along the axial direction A. Additionally or alternatively, groove 111 may extend along the circumferential direction C. Groove 111 may thus be an annular groove extending about an entire circumferential length of top surface 1101.

The container body 110 may include a first sealing member 116. First sealing member 116 may be received or positioned within groove 111. For instance, first sealing member 116 may be or include a compressive or compressible material. First sealing member 116 may be configured to form a seal (e.g., a hermetic seal) with lid assembly 120 when lid assembly 120 is attached and tightened to container body 110. For example, first sealing member 116 is configured to form a knife edge seal with respect to lid assembly 120. An exemplary compressive material may be copper, aluminum, Indium, or polytetrafluoroethylene (PTFE). In some embodiments, first sealing member 116 may form a ring around the open end of the container body 110. In some embodiments, a wire 118 may seal an underside of first sealing member 116. Wire 118 may be or include a metal, for example indium.

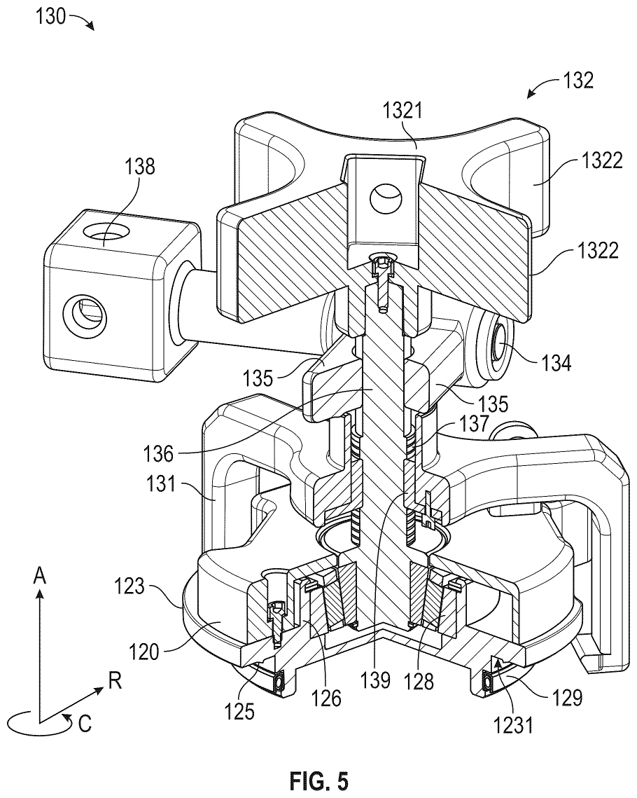

As mentioned, a knife edge seal may be formed at first sealing member 116. In an embodiment, cap member 123 (FIG. 5) may include an annular protrusion or knife edge 125. Annular protrusion 125 may protrude from cap member 123 (e.g., toward container body 110). In some instances, cap member 123 defines or includes a contact face 1231. Contact face 1231 may face toward container body 110 (e.g., along the axial direction A). Annular protrusion 125 may extend along the circumferential direction C about contact face 1231 of cap member 123. Accordingly, when lid assembly 120 is coupled to container body 110, annular protrusion 125 may cut or penetrate into first sealing member 116 (e.g., compressive material) to form the knife edge seal. It should be appreciated that a hardness of the knife edge material (e.g., annular protrusion 125) may accordingly be higher than a hardness of first sealing member 116.

In some instances, first sealing member 116 may include an O-ring. Additionally or alternatively, first sealing member 116 may include a spring-energized seal. The spring-energized seal may be preloaded. Moreover, first sealing member 116 may include a compressible piston seal. The compressible piston seal may be preloaded against sides of container body 110 and/or lid assembly 120. In some instances, first sealing member 116 is bonded to container body 110. For instance, an epoxy, a weld, or another bonding material or agent may be included to bond or fix first sealing member 116 within container body 110 (e.g., at a top surface thereof).

Wire 118 and first sealing member 116 may be situated within a groove of container body 110 (e.g., groove 111). Wire 118 may be inserted into the groove before first sealing member 116. Wire 118 may be slid or inserted into the groove with the aid of a tool, for example a flat-head screwdriver. First sealing member 116 may then be loaded on top of wire 118. First sealing member 116 may include projections 117 that allow first sealing member 116 (e.g., the compressive material) to be secured to container body 110 with one or more fasteners, for example bolts or screws.

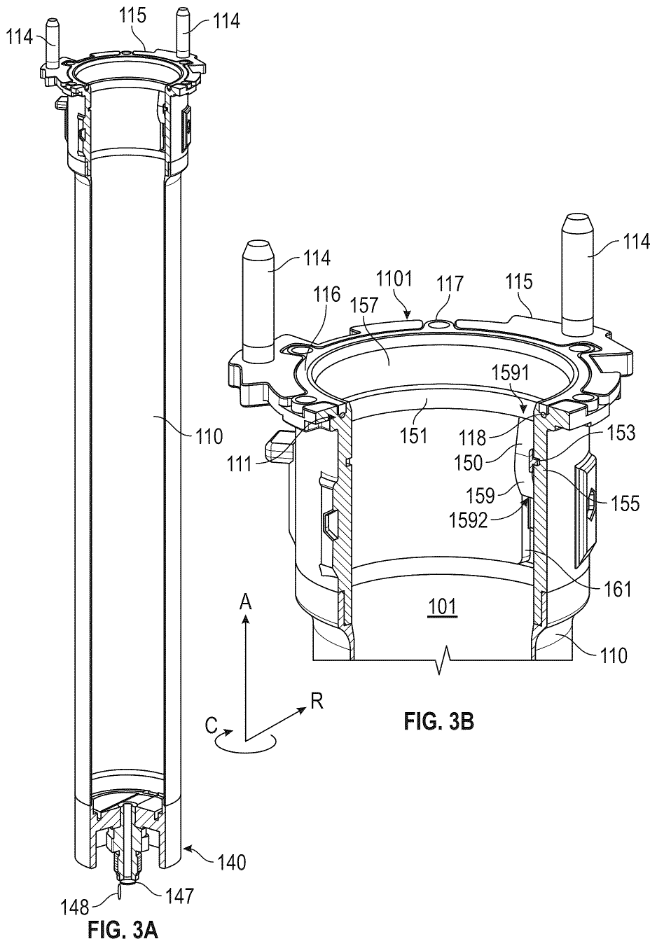

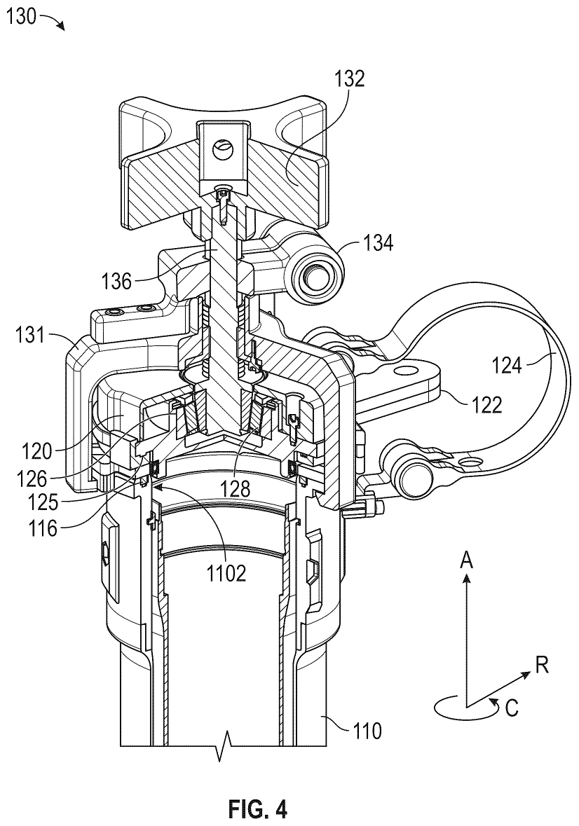

Referring now briefly to FIGS. 2 and 3A, container 100 may include an extraction device 140 situated at a distal end of container body 110 from lid assembly 120. Extraction device 140 may be a gas extraction device or fluid extraction device, for instance. As would be understood, extraction device 140 may be configured to selectively allow a release, purge, or vent of various fluids (e.g., liquids, gases, etc.) from a receiving space 101 of container body 110. As depicted in FIG. 3A, extraction device 140 may be positioned at an opposite end of container body 110 from lid assembly 120 and may be configured to allow extraction of one or more gases from within container body 110. In some embodiments, gases are extracted through extraction device 140 to form a vacuum within container body 110. In some embodiments, extraction of the gases reduces the volatility of the sample, such as when heated or brought into a pressurized environment. Extraction device 140 may provide further advantages in allowing the removed gases to be analyzed separately from the soil sample.

Extraction device 140 may be implemented or incorporated in one or more of a variety of embodiments. According to one example, extraction device 140 is or includes a gas fitting 142. For instance, gas fitting 142 may be attached to container body 110 (e.g., at a second end thereof). Gas fitting 142 maybe sealed with respect to container body 110. Gas fitting 142 may include a bracket portion 144 and an outlet adapter 146. Outlet adapter 146 may extend from bracket portion 144 (e.g., along the axial direction A).

According to at least one example, bracket portion 144 may be fixed to container body 110. For instance, bracket portion 144 may be sealed to container body 110. Accordingly, bracket portion 144 may be at least partially received within container body 110 (e.g., within receiving space 101). One or more sealing systems (e.g., methods, members, assemblies, etc.) may be incorporated at a connection point between bracket portion 144 and container body 110.

Outlet adapter 146 may be operably connected or fixed to bracket portion 144. As mentioned, outlet adapter 146 may extend along the axial direction A from bracket portion 144, such as away from receiving space 101. Outlet adapter 146 may be configured to selectively interact or mate with a dock, for instance. Advantageously, fluids (e.g., volatile gases, liquid, particles, or the like) may be removed from receiving space 101.

Outlet adapter 146 may include a latching gasket flange. For instance, extraction device 140 may include a gasket 147. Gasket 147 may be positioned at a distal end of outlet adapter 146 (e.g., distal to receiving space 101). For instance, gasket 147 may be provided at an external orifice of outlet adapter 146. Extraction device 140 may further include a latch door 148. Latch door 148 may be provided in the form of a flange door, for instance. Accordingly, latch door 148 may be movably (e.g., via a pivot, slide, hinge, or the like) coupled to outlet adapter 146. Latch door 148 may selectively provide a seal at outlet adapter 146. For instance, latch door 148 may press against gasket 147 in a latched position to seal outlet adapter 146.

Outlet adapter 146 may include a valve or valve device 149. Valve 149 may be positioned at a distal end of outlet adapter 146. For instance, valve 149 may be or include an opening and closing device configured to selectively open or close outlet adapter 146. Thus, valve 149 may selectively seal fluid access to receiving space 101. Valve 149 may be or incorporate any suitable style of valve, such as a butterfly valve, a gate valve, a needle valve, a ball valve, or the like. It should be understood that the examples provided herein are non-exhaustive, and any suitable valve style or combination of valves may be incorporated.

Extraction device 140 may include a puncture seal 143. Puncture seal 143 may be positioned at the distal end of outlet adapter 146. For instance, puncture seal 143 may be sealed to the distal end of outlet adapter 146. Puncture seal 143 may include a layer of material (e.g. a self-sealing membrane) configured to be selectively punctured (e.g., by a needle, hose, etc.). In some instances, puncture seal 143 includes or is formed from a metallic sheet. Thus, puncture seal 143 may have or define a predetermined thickness (e.g., along the axial direction A).

Referring now to FIG. 3B, container body 100 may include a soft dock 150 situated within the container body 110 and proximate to lid assembly 120. Soft dock 150 may be configured to prevent a rotational motion and an axial motion of drive tube 200 within container body 110. Soft dock 150 may also prevent a lateral (e.g., radial) motion of drive tube 200. According to at least some embodiments, soft dock 150 includes a member (or base ring) 151. Member 151 may be or include a ring member or ring shaped member positioned within receiving space 101. Member 151 may centrally align drive tube 200 within container body 100.

Member 151 may include at least one projection 153 that is sized to fit within a slot 155 in a sidewall 157 of the hollow interior of container body 110. Projection 153 may protrude from member 151 along the radial direction R and extend along the circumferential direction C, for instance. Soft dock 150 may include a plurality of retention members 159. According to at least some embodiments, soft dock 150 include three retention members 159. Retention member(s) 159 may be configured to interface with (e.g. squeeze) on drive tube 200. For instance, drive tube 200 may include one or more grooves (e.g., axial grooves) 161 formed therein. Retention members 159 may be selectively received within the grooves to reduce the risk of or prevent rotation and axial motion of drive tube 200, while also allowing drive tube 200 to be inserted with a relatively low force. Reducing the risk of, or preventing the rotation of, drive tube 200 is advantageous in that it allows the operator to disconnect or unscrew a keeper 210 (mentioned below) while holding on to container body 110. Reducing the risk of, or preventing, the axial motion of drive tube 200 is desirable to avoid having drive tube 200 fall out of container body 110.

Retention member 159 may define a first end 1591 and a second end 1592. First end 1591 may be attached to member 151. Accordingly, second end 1592 may be positioned within receiving space 101. Second end 1592 may thus be spaced apart from first end 1591. Second end 1592 may be configured to contact (e.g., interact) with drive tube 200 when drive tube 200 is inserted into receiving space 101. According to some embodiments, retention member 159 (e.g., second end 1592) is biased toward an axial center of receiving space 101.

In an embodiment, retention member(s) 159 are selectively received within a groove 161 formed into sidewall 157. In the illustrated embodiment, an exemplary retention member 159 is a generally elongated member having a curved shape that curves into the hollow interior or receiving space 101. Retention member 159 may then operably bend or deflect as drive tube 200 is inserted to apply a radial force on drive tube 200. The plurality of retention members 159 may include springs, fingers, elastics, leaf springs, or any other suitable piece that is deformable and able to return to a de-energized state. Retention members 159 may limit each of an axial movement and a rotational movement (e.g., about the circumferential direction) of drive tube 200 when drive tube 200 is received within container body 110. Additionally or alternatively, retention members 159 may provide a force inward along the radial direction such that drive tube 200 may be maintained in a predetermined radial position within container body 110 (e.g., in the instance that a drive tube 200 diameter is less than an inner diameter of container body 110).

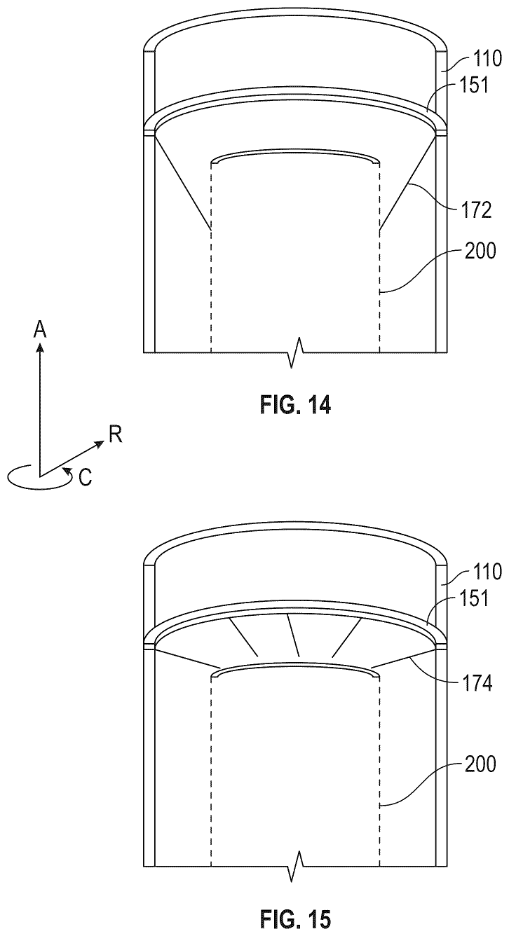

Soft dock 150 may include a metal spider design that deflects when drive tube 200 is inserted (FIG. 14). In detail, the metal spider may include a plurality of fingers (e.g., retention fingers) 172 that extend towards the center of the receiving space 101 (e.g., along the radial direction R). In some instances, fingers 172 may be directed, bent, or angled slightly downward along the axial direction A. As drive tube 200 is inserted into receiving space 101, fingers 172 may engage an outer surface of drive tube 200 and apply a biasing force. The metal spider may operably attach to drive tube 200 to prevent motion (e.g., radial, axial, etc.). In some embodiments, drive tube 200 may include one or more features that interface to the spider to prevent rotation.

Soft dock 150 may further include a spring-loaded mechanism including one or more fingers 174 that fold out of the way as drive tube 200 is inserted into receiving space (FIG. 15). Similar to fingers 172, fingers 174 may extend into receiving space 101 along the radial direction R. As drive tube 200 is inserted axially and clears the mechanism (e.g., passes through fingers 174 along the axial direction A), fingers 174 may spring back to a neutral or deenergized position to retain drive tube 200. For instance, fingers 174 may be positioned above (e.g., along the axial direction A) a top of drive tube 200 when drive tube 200 is in a fully inserted position. Advantageously, this may reduce the amount of force required to insert drive tube 200 and provides a high retention force in the axial direction A.

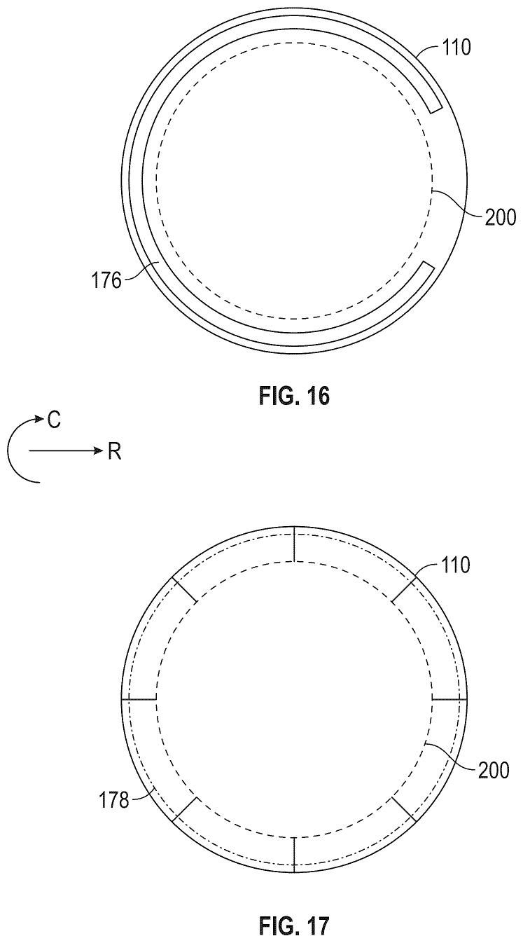

Soft dock 150 may further include a spring energized seal or clamping member 176 that allows drive tube 200 to be inserted (FIG. 16). Spring seal 176 may move radially to hold drive tube 200 in place once drive tube 200 is inserted. In some embodiments this allows drive tube 200 to be inserted all the way through receiving space 101 or can be positioned to preload against drive tube 200 (e.g., at a top position or a side wall thereof) to hold drive tube 200 radially as well. In some instances, spring seal 176 is or includes a leaf spring.

In some embodiments, soft dock 150 may include a secondary insert (or insert bracket) 178 that interfaces with container body 110 and drive tube 200 to lock drive tube 200 in place (FIG. 17). Insert bracket 178 may be or include a sleeve, for instance. Insert bracket 178 may be selectively positioned between sidewall 157 of container body 110 and drive tube 200. Insert bracket 178 may be configured to lock drive tube 200 in the inserted position within receiving space 101. According to some embodiments, insert bracket 178 is or includes a resilient member capable of adjusting between a first position or size and a second position or size to selectively grasp or hold drive tube 200. Additionally or alternatively, soft dock 150 may include a leaf spring design that grips onto drive tube 200 to prevent motion, or an aperture or hyperboloid that grasps drive tube 200 in 360 degrees by closing around drive tube 200 after insertion. This may prevent motion radially as well as preventing some vertical motion from the number of points of contact.

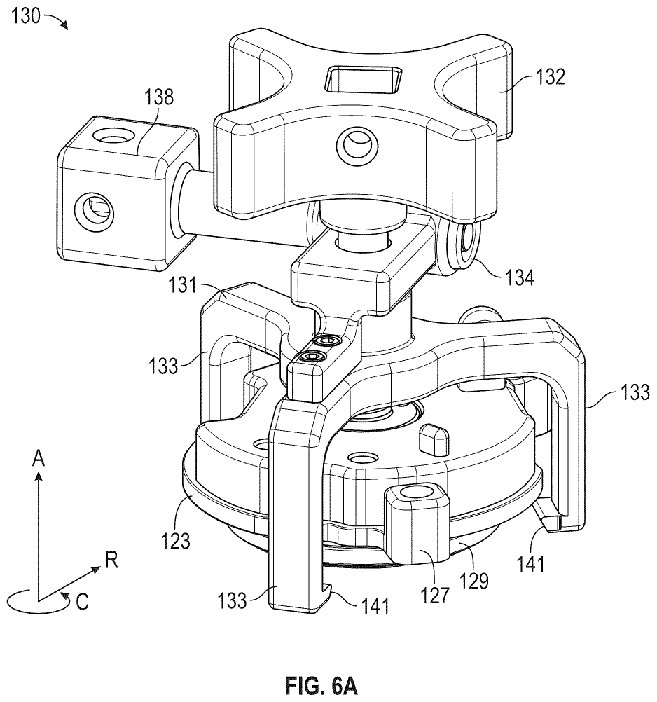

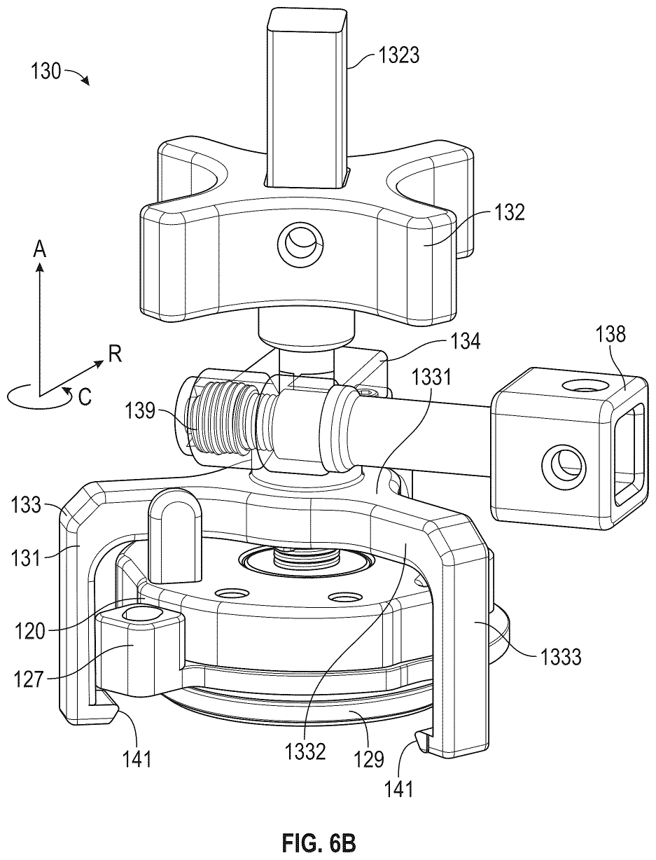

Container body 110 may also include one or more alignment pins 114 configured to interface with lid assembly 120. Alignment pins 114 may be situated at a proximal, or top, end 115 of container body 110, (e.g., an open end of container body 110 receiving the sample or drive tube 200). Alignment pins 114 may be inserted within or through an aperture 127 (FIG. 6A) of cap member 123 of lid assembly 120. For example, each alignment pin 114 may be inserted into a corresponding aperture 127. An exemplary aperture 127 is depicted in FIGS. 6A and 6B.

Referring briefly now to FIG. 2, lid assembly 120 may include one or more dust covers 122. In some embodiments, container 100 includes two dust covers 122 adjacent to one another, one (or a first) dust cover 122 seated at a bottom or underside of lid assembly 120 and another (or a second) dust cover 122 seated at a top of container body 110 (e.g., at top surface 1101). Dust covers 122 may be configured to prevent dust from entering container body 110 or from preventing formation of the seal between lid assembly 120 and container body 110 prior to insertion of drive tube 200. In other words, dust covers 122 are disposed between knife edge 125 and first sealing member 116 to prevent deformation of first sealing member 116 (e.g., the compressible material) until the forming of a seal is desired.

Referring again to FIG. 2, lid assembly 120 may be connected to container body 110 by a strap assembly 124. Strap assembly 124 may include one or more straps connected to a cover of lid assembly 120 and an outer surface of container body 110. Strap assembly 124 may allow lid assembly 120 to remain connected to container body 110 while a sample is loaded into container body 110. In an embodiment, strap assembly 124 includes a relatively thin and wide strap c-shaped body having hinge members arranged at each end. Strap assembly 124 may allow lid assembly 120 to be rotated relative to container body 110 to allow insertion of drive tube 200.

Lid assembly 120 may further include a containment seal 129 (FIG. 5) situated at the bottom of lid assembly 120. Containment seal 129 may extend about a periphery of a projection in cap member 123 and may be configured to form a sliding seal that reduces introduction of contaminants into a sample housed within container 100. In some embodiments, containment seal 129 includes a polymeric material, for example polytetrafluoroethylene.

Referring now to FIGS. 5, 6A, 6B, 10, and 11, lid assembly 120 may include a handle assembly 1301. Handle assembly 1301 may be provided as a part of lid assembly 120. For instance, handle assembly 1301 may be included as a part or portion of locking assembly 130. Handle assembly 1301 is operably coupled with a gearbox 300 (described below). In some instance, gearbox 300 is provided as a part of handle assembly 1301. Handle assembly 1301 may be configured to transmit an input (e.g., a rotational input, such as a twist motion from a user) to lid assembly 120 to seal lid assembly 120 with respect to container body 110.

Lid assembly 120 (e.g., handle assembly 1301) may include a handle or handle member 132. Handle member 132 may be situated at a top of locking assembly 120. Handle member 132 may be configured to be twisted or otherwise manipulated by a user, for example, an astronaut. In embodiments where handle member 132 is designed for use by an astronaut, handle member 132 may be sufficiently sized and shaped to be manipulated with the thick glove and limited dexterity of a spacesuit. For example, handle member 132 may include a knob 1321. Knob 1321 may include two or more lobes 1322. Lobes 1322 may extend along the radial direction R from a center of knob 1321. For instance, two lobes 1322 may be included, extending in opposite radial directions from each other.

In some embodiments, handle member 132 may be configured to be manipulated by a wrench. Additionally or alternatively, multiple handle members 132 may be included. Each of the multiple handle members 132 may be used separately or in conjunction with each other to increase a sealing force between lid assembly 120 and container body 110. A multi-handle design may allow astronauts to achieve a higher sealing force using just their hand strength. The higher sealing force may allow for the use of other sealing materials for the gasket other than a soft indium seal that was used, for example, with containers on the NASA Apollo moon landing missions, which led to sample contamination issues. An added mechanical advantage may be observed from the distribution of force and reduced input torque on each lead screw necessary to seal.

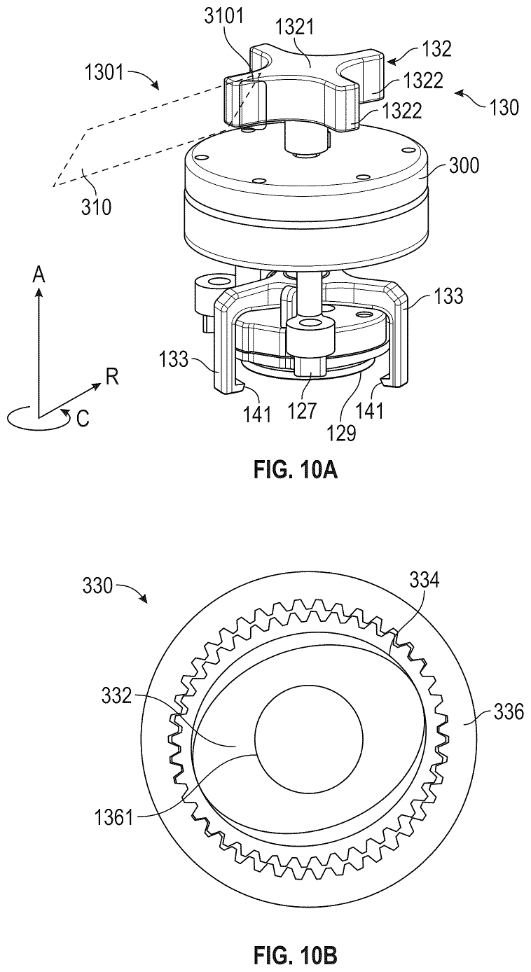

Handle 132 may include a lever arm 310. Lever arm 310 may extend from handle 132 (e.g., along the radial direction R). For example, an extension length of lever arm 310 along the radial direction R may be greater than an extension length along the radial direction R of each lobe 1321. In some instances, lever arm 310 includes a hinge 3101 that allows the arm to fold with respect to handle 132. For one example, lever arm 310 may fold radially inward toward handle member 132. For another example, lever arm 310 may fold axially with respect to handle member 132 (e.g., upward or downward). Accordingly, lever arm 310 may be movable (e.g., foldable, adjustable, etc.) between a retracted position and an extended position (e.g., FIG. 10). Additionally or alternatively, lever arm 310 may be removably coupled to handle 132 (e.g., via one or more fasteners).

In still further embodiments, lever arm 310 may be a telescopic arm. In detail, lever arm 310 may include a plurality of segments movably nested within each other such that a total length (e.g., in the radial direction R) of lever arm 310 may be increased or decreased. It is hereby noted that a telescopic assembly would be understood by one having ordinary skill in the art, and as such a detailed description thereof will be omitted for the sake of brevity.

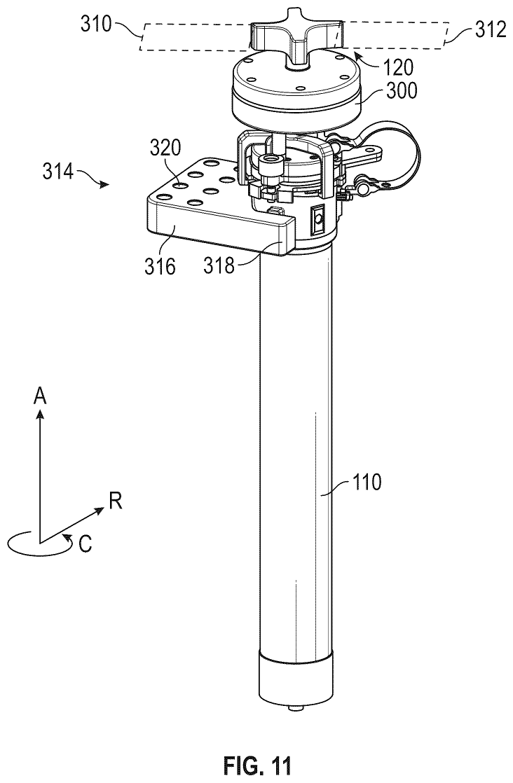

In some instances, lever arm 310 is a first lever arm. For instance, handle member 132 may include a second lever arm 312 (e.g., in addition to first lever arm 310). Second lever arm 312 (FIG. 11) may extend in the radial direction opposite from first lever arm 310. Second lever arm 312 may be substantially similar to first lever arm 310 (e.g., telescopic, foldable, etc.). Accordingly, handle assembly 1301 may include a second hinge (not shown) movably coupling second lever arm 312 to handle member 132. In some instances, first lever arm 310 and second lever arm 312 are provided as a single unitary member (e.g., lever arm 310). In such embodiments, lever arm 310 includes a first arm portion extending along the first radial direction and a second arm portion extending along the second radial direction opposite the first radial direction, as would be understood. Further, each of the first arm portion and the second arm portion may be foldable between a retracted position and an extended position.

Moreover, handle member 132 may include a crank handle 1323 (FIG. 6B). Crank handle 1323 may protrude up (e.g., along the axial direction A), such as predominantly parallel with the axis of container body 110. Crank handle 1323 may allow a user to apply a larger amount of torque to the sealing mechanism than what is available via wrist torque. Crank handle 1323 may be configured to be folded down with respect to handle member 132 (e.g., with respect to knob 1321). In some instances, crank handle 1323 is a separate attachment that interfaces with (e.g., connects to) handle member 132.

Further still, handle 132 may include a two-handed lever arm, in which the user grabs both sides of the lever to apply torque. The two-handed lever arm could be folded down with the handle. The two-handed lever arm could be a separate attachment that interfaces with the handle. For instance, the two-handed lever arm may be formed from a single piece extending along the radial direction R. Accordingly, the two-handed lever arm may be coupled to, e.g., handle 132 at or near a midpoint of the lever arm along the radial direction R.

Locking assembly 130 may include a claw member 131. Claw member 131 may include a plurality of arms 133. For instance, claw member 131 may include three arms 133 spaced equidistant from each other about the circumferential direction C. However, it should be understood that anu suitable number of arms 133 may be included in specific embodiments. Arms 133 may selectively extend over lid assembly 120 and attach to the container body 110 (e.g., when lid assembly 120 is in an attached position to container body 110). Hereinafter, a single arm 133 will be described with the understanding that the description may apply to each arm included in specific embodiments.

Referring briefly to FIG. 6B, claw member 131 may include a carriage body 1331. Carriage body 1331 may be positioned around shaft 136. For instance, carriage body 1331 may be predominantly annular shaped. Arm 133 may extend from carriage body 1331. In detail, arm 133 may include a radial portion 1332 and an axial portion 1333. Radial portion 1332 may extend from carriage body 1331 (e.g., predominantly along the radial direction R). Axial portion 1333 may extend from a distal end of radial portion 1332 (e.g., predominantly along the axial direction A). Axial portion 1333 may extend toward container body 110.

In at least some embodiments, arm 133 includes a lip 141. Lip 141 may extend predominantly along the radial direction R (e.g., toward container body 110). In operation, lip 141 may engage a groove formed in container body 110, such that when handle 132 is rotated, claw member 131 engages container body 110 and allows lid assembly 120 to be translated under the force of shaft 136 into container body 110 to form the seals described herein. For instance, lid assembly 120 is pulled into a top surface of container body 110 when handle 132 is rotated.

Locking assembly 130 may further include a locking clamp 134 operably connected to handle 132. In an embodiment, locking clamp 134 includes a pair of arms 135 that extend about input shaft or preload shaft 136. As discussed below, arms 135 may be configured to squeeze or clamp about shaft 136 to prevent rotation of shaft 136 and lock shaft 136 in place. In an embodiment, shaft 136 includes an end in physical contact with a surface of cap member 123 of lid assembly 120. Shaft 136 may include one or more threaded portions 137 that allow shaft 136 to translate relative to claw member 131 and compress shaft 136 against lid assembly 120 to form the seals described herein and further secure lid assembly 120 against container body 110. In an embodiment, threaded portions 137 engage a threaded collar 139 that is coupled to claws 131. In some embodiments the bolt could screw or clamp into a planetary gearbox mechanism (described below) to a prevent rotation thereof.

Additionally or alternatively, locking assembly 130 may include a latch (not shown). The latch may be selectively coupled with one of handle 132, shaft 136, arms 135, or the like. The latch may be configured to be manually actuated (e.g., by a gloved human such as an astronaut). Moreover, locking assembly 130 may include a cap or nut (not shown) configured to operably couple shaft 136 with claws 131. Accordingly, the cap or nut may prevent relative motion between shaft 136 and claws 131 to reduce the risk of lid assembly 120 loosening relative to container body 110. In some embodiments, a secondary container (e.g., a separate vessel from vacuum sealable container 100) may include one or more locking features to which lid assembly (e.g., handle 132, shaft 136, claws 131, etc.) may be attached to prevent or reduce the risk of a loosening thereof.

In some embodiments, lid assembly 120 includes one or more rings 126 situated around shaft 136. Rings 126 may include angled surfaces that engage corresponding surfaces on shaft 136 to distribute the forces generated by shaft 136 on lid assembly 120 and also keep shaft 136 centered thereon. Lid assembly 120 may include one or more tapered roller bearings 128 configured to reduce friction generated by compression of shaft 136.

Locking assembly 130 may include a locking bolt 138 configured to lock locking clamp 134 around shaft 136. In some embodiments, locking clamp 134 includes a retaining ring situated around a locking threaded insert 139 (e.g., a Heli-coil™) of the locking bolt 138. Threaded insert 139 may include threading around a distal end of locking bolt 138. When actuated, a rotation of locking bolt 138 may cause arms 135 of locking clamp 134 to compress onto shaft 136.

In some embodiments, prior to insertion of drive tube 200, when lid assembly 120 and locking assembly 130 are placed on container body 110, handle 132 may be rotated counterclockwise to lower claw member 131 out of a stowed position to a lower or engaged position. At this point, dust covers 122 may be removed and drive tube 200 inserted. Lid assembly 120 and locking assembly 130 may then be rotated to fit claw member 131 within one or more grooves located on container body 110. After fitting claw member 131 into the grooves, a user may rotate handle 132 (e.g., clockwise), causing threaded portions 137 of shaft 136 to translate claw member 131 to engage container body 110. Once engaged, further rotation of handle 132 may drive lid assembly 120 into container body 110 to seal drive tube 200 within container body 110. The user may then tighten locking bolt 138 to lock handle 132 in place and keep the seals from disengaging.

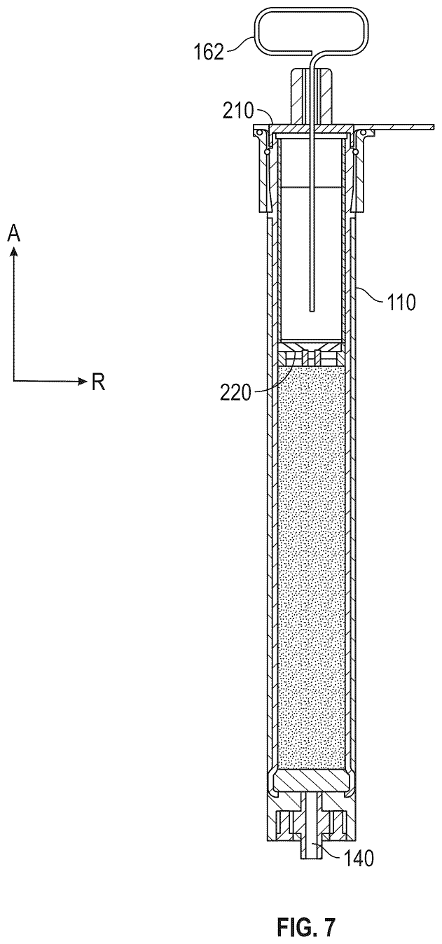

Referring now to FIG. 7, an embodiment is shown of a plug 220 that may be used to compress a sample within vacuum sealable container 100 prior to sealing. For example, plug 220 may be pushed into container body 110 by a ram rod 162. During compression of the sample, lid assembly 120 and connected locking assembly 130 may sit or rest outside container body 110, or may be connected to container body 110 via strap assembly 124.

Referring now to FIG. 8, in some embodiments a sample may be collected by the astronauts in a separate container, referred to herein as a drive tube 200. A proximal, or top, end 202 of drive tube 200 may be screwed onto a keeper 210. In some embodiments, plug 220 (FIG. 7) may be or include a metallic or polymeric material. A distal, or bottom, end 204 of drive tube 200 may be covered with a cap 230. In some embodiments, cap 230 may be or include polytetrafluoroethylene. It should be appreciated that in some embodiments where the sample does not completely fill drive tube 200, plug 220 may be disposed or positioned within container body 200, similar to that shown in FIG. 7. In some instances, one or more additional components may be disposed or provided between plug 220 and keeper 210 to keep plug 220 in contact with the sample while it is being transported.

Drive tube 200 may be inserted into container body 110 such that cap 230 contacts gas fitting 140. In some embodiments, drive tube 200 may be rotated within container body 110 until drive tube 200 locks into place within soft dock 150.

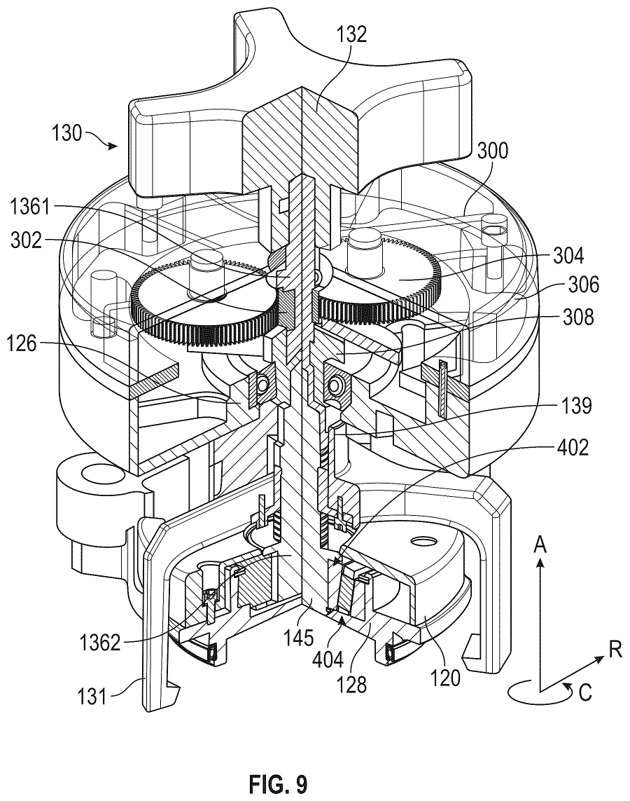

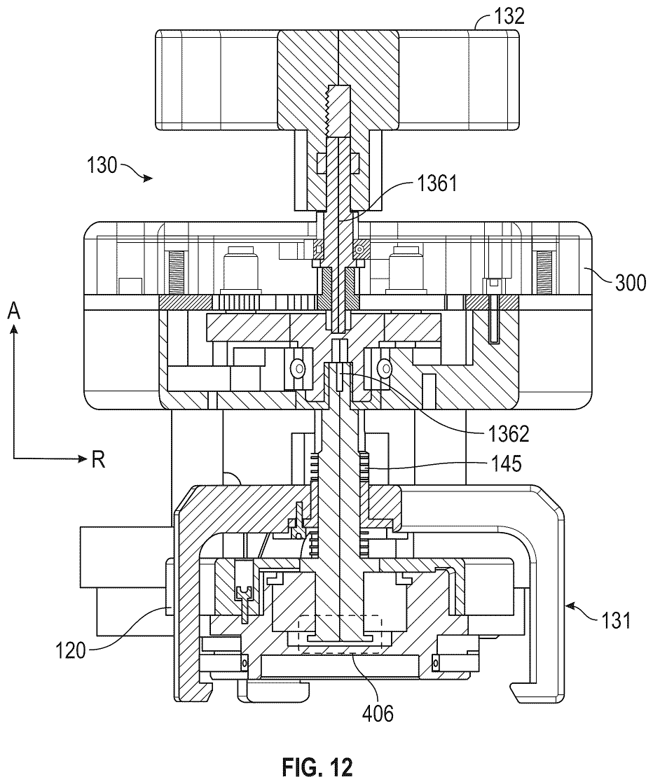

Referring now to FIGS. 9 through 13, vacuum sealable container 100 may include a gearbox 300. Gearbox 300 may be operably coupled with, or integrated into, lid assembly 120. For instance, gearbox 300 may be configured to be geared with preload shaft 136. For one example, preload shaft 136 includes an input shaft 1361 and an output shaft 1362. Gearbox 300 may be a planetary gearbox, for example, coupling input shaft 1361 with output shaft 1362. Accordingly, gearbox 300 may include a sun gear 302, a plurality of planetary gears 304, and a ring gear 306. Sun gear 302 may be provided on input shaft 1361. For instance, sun gear 302 may be fixed to input shaft 1361 so as to receive a rotational input from input shaft 1361 (e.g., via handle 132) and rotate together with input shaft 1361. Each of the plurality of planetary gears 304 may be engaged (e.g., toothedly engaged) with sun gear 302. Thus, as would be expected, each of the planetary gears 304 may revolve around sun gear 302. Ring gear 306 may be position radially outward from planetary gears 304. Accordingly, torque from input shaft 1361 (e.g., via handle 132) may be transmitted through sun gear 302 to planetary gears 304. Ring gear 306 may provide a circumferential barrier or limit to maintain planetary gears 304 in contact with sun gear 302.

Gearbox 300 may include a planetary gear carrier 308. Each of the plurality of planetary gears 304 may be operably coupled to planetary gear carrier 308. For instance, an axis of rotation of each of the plurality of planetary gears 304 may be defined in or on planetary gear carrier 308. Thus, as the plurality of planetary gears 304 revolve around sun gear 302 and thus rotate accordingly, planetary gear carrier 308 may revolve about input shaft 1361 (e.g., at a different rate or rotational speed).

Planetary gear carrier 308 may be attached or fixed to output shaft 1362. For instance, planetary gear carrier 308 may be configured to provide a rotational force to output shaft 1362 in order to rotate output shaft 1362. Accordingly, output shaft 1362 may rotate at a different rotational speed (and subsequently have a different rotational torque) than input shaft 1361. Output shaft 1362 may be operably coupled with claw members 131 (e.g., locking assembly 130).

In some instances, gearbox 300 may be or include a harmonic drive or harmonic drive gearbox 330 (FIG. 10B). For instance, gearbox 300 may include a strain wave generator 332, a flex spline or elliptical gear 334, and a ring gear 336, as would be understood. Input shaft 1361 may have the strain wave generator 332 attached thereto. Thus, output shaft 1362 may have the flex spline 334 attached thereto. As would be understood, the harmonic drive 330 may produce a relatively high gear ratio, resulting in added mechanical advantage at output shaft 1362 in the form of increased torque. Advantageously, lid assembly 120 may be pulled toward container body 110 (e.g., via claw member 131) with increased force using hand power from a user.

Output shaft 1362 may be referred to as a lead screw. In some embodiments, lid assembly 120 includes a separate lead screw 145. Lead screw 145 may be operably coupled with output shaft 1362. For instance, lead screw 145 may receive a rotational force input from output shaft 1362 and convert the force to an axial force to press lid assembly 120 against container body 110. As mentioned above, as output shaft 1362 is rotated, threaded collar 139 may translate axially therealong in order to seal lid assembly 120 to container body 110. Lead screw 145 may be operably coupled with claw member 131. For instance, as mentioned above, claw member 131 may be configured to translate along lead screw 145 as lead screw 145 is rotated.

At least one of output shaft 1362 or lead screw 145 may include a lubricant. The lubricant may be applied to the threads of lead screw 145, for example. In some instances, each of lead screw 145 and a portion of claw member 131 may have the lubricant applied thereto. The lubricant may be one of a dry lubricant or wet lubricant. Additionally or alternatively, the lubricant may be applied to planetary gear carrier 308.

According to some embodiments, handle assembly 1301 may be or include a press handle assembly. For instance, lead screw 145 may be or include a rack gear. Lead screw 145 may include a series of linear teeth formed into a shaft, as would be understood. Handle 132 may be or include a press lever. Additionally or alternatively, handle 132 (or handle assembly 1301) may include a pinion gear attached thereto (e.g., at an axial end thereof). The pinion gear may be configured to mesh with the rack gear of lead screw 145. Thus, as the press lever is pushed down, the pinion gear may adjust (e.g., move) the rack gear along the axial direction to press cap member 120 into container body 110.

Lid assembly 130 may include one or more seals. In detail, lid assembly 130 may include a first seal 402 and a second seal 404. Each of first seal 402 and second seal 404 may be positioned at or around lead screw 145. For instance, first seal 402 may be positioned at a first end of lead screw 145 (e.g., at a connection with output shaft 1362). First seal 402 may be or include a dynamic seal. Accordingly, first seal 402 may maintain a seal between at least one of lead screw 145 or output shaft 1362 and, for example, gearbox 300 when output shaft 1362 (and subsequently, lead screw 145) is rotated.

Similarly, second seal 404 may be positioned at a second end of lead screw 145 (e.g., adjacent to or at cap member 123). Second seal 404 may be or include a dynamic seal. Accordingly, second seal 404 may allow lead screw 145 to rotate with respect to cap member 123. Collectively, first seal 402 and second seal 404 may assist in retaining a liquid (e.g., a wet lubricant) within lead screw 145 (e.g., within a mechanism including lead screw 145).

According to at least some embodiments, an anti-galling material may be provided at the threads of output shaft 1362. For instance, the threads (or threaded portion) of lead screw 145 may be formed from, made of, or otherwise include an anti-galling material (e.g., Nitronic-60). Accordingly, lead screw 145 may be resistant to galling, pitting, wear, and the like, advantageously increasing the lifespan thereof and reducing potential of failure.

In still further embodiments, lid assembly 120 may include a bushing or bearing 406. For one example, bushing 406 may be provided or positioned at cap member 123. In some embodiments, bushing 406 is embedded within cap member 123 (e.g., along the axial direction A). Bushing 406 may be configured to operably couple with lead screw 145. For instance, the second end of lead screw 145 may be accepted within bushing 406. Moreover, lead screw 145 may be configured to rotate within bushing 406. Thus, friction between lead screw 145 and cap member 123 may be reduced (e.g., as. planetary gear carrier 308 is moved to a locked position).

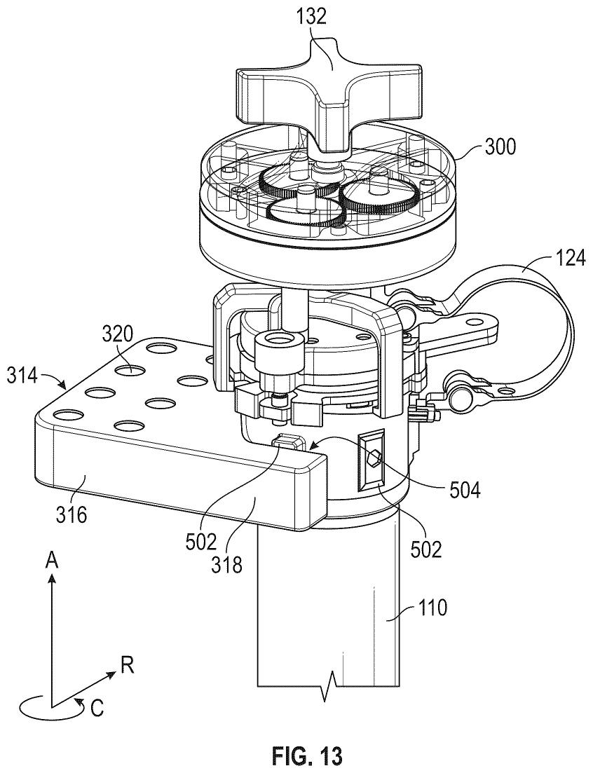

Vacuum sealable container 100 may include a bracket 314 (FIGS. 11 and 13). In some instances, multiple brackets 314 may be included. Bracket 314 may be attachable to container body 110 (e.g., at an external surface thereof). Bracket 314 may include a body 316 and an attachment portion 318. Attachment portion 318 may be or include a pair of arms formed in a semi-circle. As would be understood, a receiving groove may be formed or defined between the pair of arms. Attachment portion 318 may thus partially surround and attach to container body 110. For instance, attachment portion 318 may clip on to container body 110.

According to at least some embodiments, container body 110 include at least one torque reaction component 502. Torque reaction component 502 may extend from an external surface of container body 110 (e.g., along the radial direction R). Torque reaction component 502 may selectively interact with (e.g., couple to) bracket 314 (e.g., to attachment portion 318). Torque reaction component 502 may be or include a protrusion tab protruding along the radial direction R and extending along the axial direction A. In some instances, a plurality of protrusion tabs are provided as individual torque reaction components 502.

Bracket 314 may include or define at least one channel 504. In some instances, multiple channels 504 are defined. For instance, channel 504 may be configured to accept torque reaction component 502 therein. Accordingly, channel 504 may be formed into attachment portion 318. Channel 504 may extend along the axial direction A. For instance, channel 504 may extend from a top to a bottom of bracket 314 (e.g., main body 316 or attachment portion 318). Thus, torque reaction component 502 may be selectively received within channel 504 (e.g., along the axial direction A). Advantageously, container body 110 may be restricted from rotating when inserted into bracket 314.

Bracket 314 may include a fastener hole 320. Thus, bracket 314 may be selectively attachable to an external coupling (e.g., in addition to attaching to container body 110). In some instances, the external coupling is a vehicle (e.g., a lunar rover or other space vehicle), a utility belt (e.g., of an astronaut), a ladder, a shelf, or the like. Additionally or alternatively, bracket 314 may be attached to any suitable portion of container 100, such as lid assembly 120, locking assembly 130, or the like. In some embodiments, bracket 314 is fixed to container body 110. Accordingly, bracket 314 (and subsequently container body 110) may be attached to the external coupling collectively.

In additional or alternative embodiments, a worm gear may be included. A worm gear design may allow astronauts to achieve a higher sealing force (e.g., between the lid assembly and the container body) using just hand strength. The higher sealing force may allow for the use of other sealing materials for the gasket other than a soft indium seal to reduce the risk of contamination.

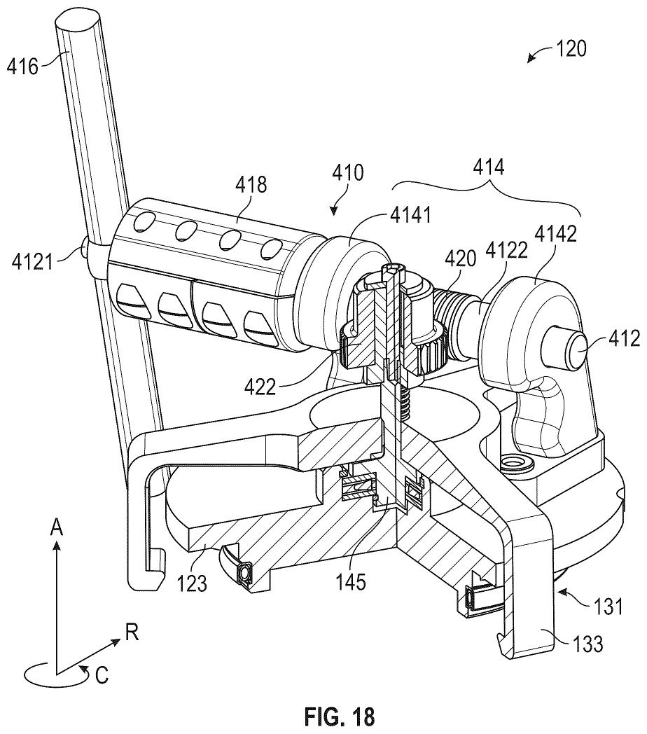

For instance, with reference to FIG. 18, container 100 may include a worm gear assembly 410. Worm gear assembly 410 may be operably coupled with lid assembly 120. According to at least some embodiments, worm gear assembly 410 is provided alternatively to handle assembly 1301. Additionally or alternatively, worm gear assembly 410 may be provided in place of gearbox 300.

Worm gear assembly 410 may include a worm shaft 412. Worm shaft 412 may be rotatable about a first axis. For instance, the first axis may be predominantly perpendicular to the axial direction A (e.g., of container body 110). Worm shaft 412 may be supported via one or more frame members 414. For instance, a first frame member 4141 and a second frame member 4142 may be attached, fixed, or otherwise coupled to lid assembly 120 (e.g., to cap member 123). Frame members 414 may be spaced apart from each other along the radial direction R. Frame members 414 may be configured to rotatably support worm shaft 412. Thus, in some instances, each of first frame member 4141 and second frame member 4142 may include a bearing, bushing, or other rotational element configured to allow worm shaft 412 to rotate thereupon.

Worm gear assembly 410 may include a worm handle 416. Worm handle 416 may be coupled with worm shaft 412. Worm handle 416 may be or include any suitable handle style, such as a lever handle, a knob handle, or the like. Thus, worm handle 416 may be positioned at an axial end of worm shaft 412. Worm handle 416 may be configured to impart a rotational force to worm shaft 412 in response to an input from a user, such as a hand turn or hand crank.

According to some embodiments, worm gear assembly 410 may include a worm gearbox 418. Worm gearbox 418 may be operably connected with worm shaft 412. For instance, worm shaft 412 may include an input shaft 4121 and an output shaft 4122. Input shaft 4121 may be connected with worm handle 416, for instance. Worm gearbox 418 may thus operably connect input shaft 4121 with output shaft 4122. Worm gearbox 218 may provide a gear reduction (e.g., between input shaft 4121 and output shaft 4122) during a rotational input to input shaft 4121. According to some embodiments, worm gearbox 418 includes a plurality of reduction gears meshed together between input shaft 4121 and output shaft 4122. It should be understood that worm gearbox 418 may be or include any suitable style of gearbox, such as a sequential gearbox, a planetary gearbox, or the like.

Worm gear assembly 410 may include a shaft gear (or worm gear) 420. Shaft gear 420 may be provided at output shaft 4122. For instance, shaft gear 420 may be or include a threaded portion (e.g., such as a threaded collar) attached to output shaft 4122. Shaft gear 420 may be configured to transmit or convert the rotational input from worm shaft 412 to a preload shaft (e.g., output shaft 1362, lead screw 145, etc.). For instance, worm gear assembly 410 may include an output gear (or worm wheel) 422. Worm wheel 422 may be attached to the preload shaft (e.g., lead screw 145). Accordingly, as worm shaft 412 is rotated, the rotational force may be transmitted through shaft gear 420 and worm wheel 422 to adjust or move claw member 131 with respect to cap member 123.

In additional or alternative embodiments, a bolt pattern may be included to bolt the lid assembly to the container body. The added bolt pattern may allow for extra mechanical advantage and allow for astronauts to seal the container to a very high level (i.e., high sealing force, low leak rate) using only their strength. The added mechanical advantage may stem from the distribution of force and reduced input torque on each screw necessary to seal.

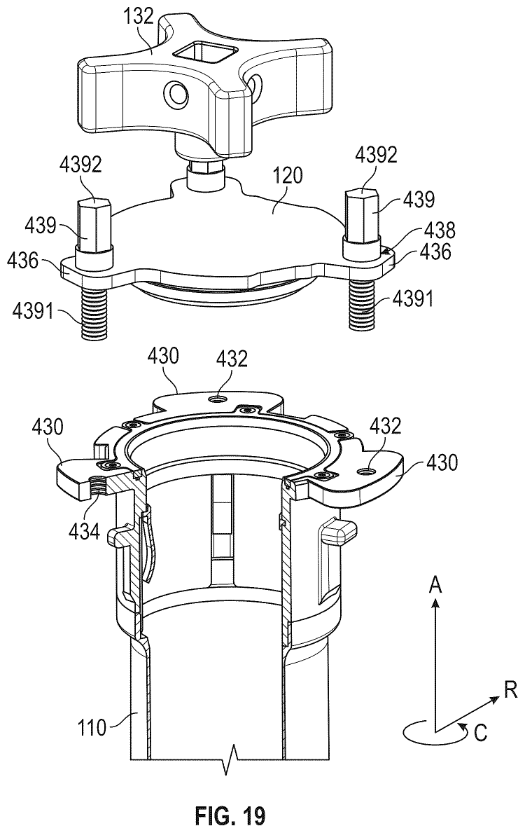

Referring briefly to FIG. 19, container body 110 may include at least one flange tab 430. In some embodiments, multiple flange tabs 430 are included. Hereinafter, a single flange tab 430 will be described with the understanding that the description may apply to any suitable number of flange tabs 430. For instance, flange tab 430 may protrude from a top portion of container body 110 along the radial direction R. Additionally or alternatively, flange tab 430 may extend at least partially along the circumferential direction C. In such embodiments where a plurality of flange tabs 430 is included, the plurality of flange tabs 430 may be spaced apart from each other equidistant about container body 110 along the circumferential direction C.

Flange tab 430 may define a through aperture 432. For instance, through aperture 432 may penetrate flange tab 430 along the axial direction A. In some instances, through aperture 432 is threaded. For instance, an internal thread 434 may be formed into through aperture 432. Accordingly, through aperture 432 may be configured to receive a threaded insert of fastener therein, explained below.

Lid assembly 120 may include at least one lid tab 436. In some embodiments, multiple lid tabs 436 are included. Hereinafter, a single lid tab 436 will be described with the understanding that the description may apply to any suitable number of lid tabs 436 included in specific embodiments. Lid tab 436 may correspond with flange tab 430 of container body 110. For instance, lid tab 436 may protrude from cap member 123 along the radial direction R and extend at least partially along the circumferential direction C. In such embodiments where a plurality of lid tabs 436 is included, the plurality of lid tabs 436 may be spaced apart from each other equidistant about cap member 123 along the circumferential direction C.

Lid tab 436 may define a through hole 438. For instance, through hole 438 may protrude through lid tab 436 along the axial direction A. Through hole 438 may be aligned with through aperture 432 along the axial direction (e.g., when lid assembly 120 is coupled to container body 110). Thus, lid tab 436 may come into planar contact with flange tab 430. Additionally or alternatively, lid assembly 120 may include a locking bolt 439. Locking bolt 439 may be received within through hole 438 (e.g., along the axial direction A).

In some instances, locking bolt 439 is configured to rotate freely within through hole 438. Locking bolt 439 may define a threaded portion 4391. For instance, locking bolt 439 may be configured to interact or engage with through aperture 432 (e.g., when lid assembly 120 is attached to container body 110). Locking bolt 439 may further include a cap portion 4392. Cap portion 4392 may be provided at a top axial end of locking bolt 439 (e.g., above lid tab 436 along the axial direction A). Cap portion 4392 may be configured to interact with or connect with a handle or handle member (e.g., handle member 132, knob 1321, etc.). Thus, cap portion 4392 may include anti-rotation features. In some instances, cap portion 4392 is hexagonal shaped (e.g., similar to a hex bolt). Accordingly, a handle member may be selectively fitted over cap portion 4392 to allow for a rotational input to be subjected thereto.

Further still, a cam lock may be included between the lid assembly and the container body. The cam lock may provide for added sealing force between the lid assembly and the container body. The added cam locks allows for extra mechanical advantage and allows for users (i.e. astronauts) to seal the container to a very high level (i.e., high sealing force, low leak rate) using only their hand strength. The added mechanical advantage comes from the distribution of force and reduced input torque on each screw necessary to seal.

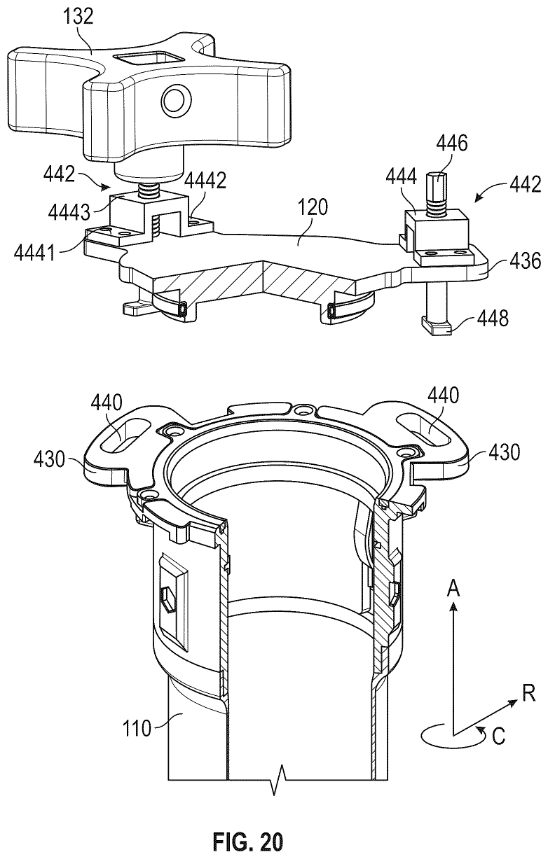

For instance, referring briefly to FIG. 20, flange tab 430 may define an alignment slot 440. Alignment slot 440 may protrude through flange tab 430 along the axial direction A. Additionally or alternatively, alignment slot 440 may extend at least partially along the circumferential direction C. In some instances, alignment slot 440 is or includes a linear slot extending along a tangential direction to the circumferential direction C. As would be understood, each included flange tab 430 may include a respective alignment slot 440 as specific applications warrant.

Lid assembly 120 may include a cam lock assembly 442. For instance, cam lock assembly 442 may be provided at lid tab 436. Cam lock assembly 442 may include a cam bracket 444. Cam bracket 444 may be attached at lid tab 436. For instance, cam bracket 444 may extend upward along the axial direction A from lid tab 436 (e.g., away from container body 110). Cam bracket 444 may be configured to threadedly receive a cam bolt (described below) therethrough (e.g., along the axial direction A). For instance, cam bracket 444 may define a first arm 4441, a second arm 4442, and a main plate 4443. Main plate 4443 may be predominantly parallel with lid tab 436. Additionally or alternatively, main plate 4443 may be spaced apart from lid tab 436 (e.g., along the axial direction A).

Cam lock assembly 442 may include a cam bolt 446. Cam bolt 446 may extend through each of cam bracket 444 and lid tab 436 (e.g., along the axial direction A). Cam bolt 446 may be rotatable with respect to cam bracket 444. For instance, cam bolt 446 may translate along the axial direction A with respect to cam bracket 444 in response to a rotational input thereto. Accordingly, cam bolt 446 may be threadedly received through cam bracket 444.

Cam bolt 446 may include or define a cam extension 448. Cam extension 448 may be positioned at a bottom axial end of cam bolt 446 (e.g., below lid tab 436 along the axial direction A). Cam extension 448 may extend radially from cam bolt 446. For instance, cam extension 448 may extend in each of a first radial direction and a second radial direction opposite the first radial direction from cam bolt 446. Thus, cam extension 448 may form or define a locking arm. For instance, when lid assembly 120 is attached to container body 110, cam extension 448 may pass through alignment slot 440. Cam bolt 446 may then be turned or twisted (e.g., via a handle or knob) and cam extension 448 may pass or slide under flange tab 430. By way of a camming action, lid assembly 120 may be pulled into container body 110 to force annular protrusion 125 into first sealing member 116.

Further still, a C-clamp may be used to fasten the lid assembly to the container body. The added c-clamp may allow for additional mechanical advantage and allows for astronauts to seal the container to a very high level (i.e., high sealing force, low leak rate) using only their hand strength. The added mechanical advantage may come from the distribution of force and reduced input torque on each lead screw necessary to seal. A c-clamp design may allow astronauts to achieve a higher sealing force using just their hand strength. The higher sealing force may allow for the use of other sealing materials for the gasket other than a soft indium seal.

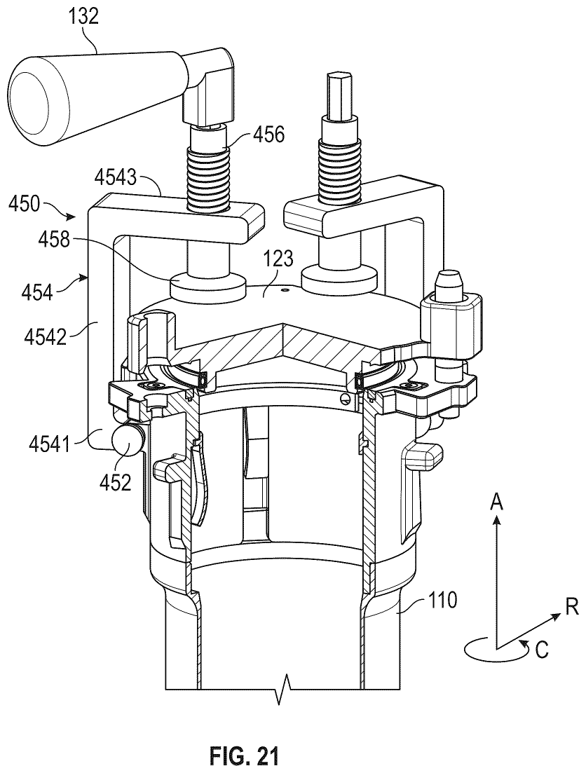

For instance, referring briefly to FIG. 21, container 100 may include one or more C-clamp assemblies or C-clamps 450. According to some embodiments, three C-clamps 450 are included. However, it should be understood that any suitable number of C-clamps 450 may be included in specific applications. Hereinafter, a single C-clamp assembly 450 will be described with the understanding that the description may apply to any suitable number of C-clamps 450 included in specific applications.

C-clamp assembly 450 may be attached to container body 110. For instance, C-clamp assembly 450 may include a hinge or hinge join 452. Hinge 452 may be positioned at an outer circumferential face of container body 110. Hinge 452 may allow C-clamp assembly 450 to rotate away from container body 110 (e.g., along the radial direction R). C-clamp assembly 450 may further include a clamp frame 454. Clamp frame 454 may have a predominantly C shape, as would be understood. Accordingly, when in a clamping position, clamp frame 454 may include a first arm 4541 extending along the radial direction R, a second arm 4542 extending along the axial direction A, and a third arm 4543 extending along the radial direction R.

A length of third arm 4543 along the radial direction R may be greater than a length of first arm 4541 along the radial direction R. Thus, when in the clamping position, a distal end of third arm 4543 may be positioned over a portion of cap member 123 along the axial direction. C-clamp assembly 450 may include a clamping shaft 456. Clamping shaft 456 may extend through third arm 4543 of clamp frame 454 (e.g., along the axial direction A when in the clamping position). Clamping shaft 456 may be threadedly coupled to clamp frame 454. Thus, when rotated, clamping shaft 456 may translate along the axial direction A.

Clamping shaft 456 may include a clamp foot 458. Clamp foot 458 may be positioned at a bottom axial end of clamping shaft 456 (e.g., adjacent to cap member 123 when in the clamping position). A diameter of clamp foot 458 may be greater than a diameter of clamping shaft 456. Clamp foot 458 may be configured to press cap member 123 toward container body 110 in response to the rotational input to clamping shaft 456. For instance, clamping shaft 456 may include a handle or knob (e.g., handle 132). In some instances, the handle may be detachably coupled to clamping shaft 456. Advantageously, clamp foot 458 may press annular protrusion 125 into first sealing member 116.

Further still, a flange-clamp may be used to fasten the lid assembly to the container body. The added flange clamp may allow for additional mechanical advantage and allow for astronauts to seal the container to a very high level (i.e., high sealing force, low leak rate) using only their hand strength. The added mechanical advantage may come from a wedge on the clamp and a thread that is used to compress it. The higher sealing force may allow for the use of other sealing materials for the gasket other than a soft indium seal. Additionally, the design can be used without the addition of another bracket to react the sealing torque, as the astronaut can react the torque by holding the container when tightening the flange.

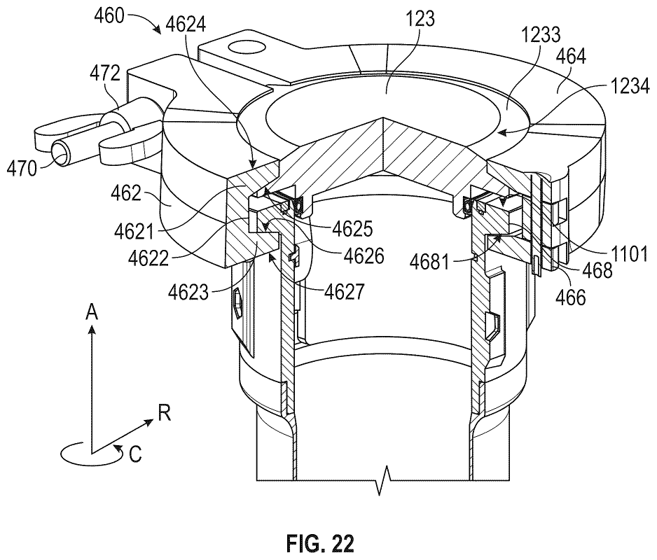

For instance, referring to FIG. 22, container 100 may include a flange clamp 460. Flange clamp 460 may be selectively positioned around container body 110 (e.g., at a top portion thereof) and lid assembly 120 (e.g., cap member 123) collectively. Flange clamp 460 may include a first body 462 and a second body 464. First body 462 may be rotatably coupled with second body 464. For instance, flange clamp 460 may include a hinge or hinge pin 466 extending along the axial direction A. Thus, second body 464 may rotate with respect to first body 462 about hinge 466.

First body 462 may be curved. For instance, first body 462 may have a predominantly semi-circular shape, extending along the circumferential direction C. First body 462 may define a C shaped cross-section, taken along the circumferential direction C. For instance, first body 462 may define a first section 4621, a second section 4622, and a third section 4623. The respective sections may be positioned in sequential order along the axial direction, such that first section 4621 is positioned above second section 4622, which is in turn positioned above third section 4623.

First section 4621 may have a first thickness, while second section 4622 may have a second thickness and third section 4623 may have a third thickness along the radial direction R. The first thickness may be substantially similar to the third thickness. Additionally or alternatively, the second thickness may be less than each of the first thickness and the third thickness. Accordingly, a circumferential channel may be formed at second section 4622 (e.g., between first section 4621 and third section 4623).

First section 4621 may include a top surface 4624 and a bottom surface 4625. For instance, bottom surface 4625 may form at least a portion of the circumferential channel. A width along the axial direction A of first section 4621 (e.g., between top surface 4624 and bottom surface 4625) may reduce along the radial direction R (e.g., from second section 4622 toward a distal end of first section 4621). Accordingly, bottom surface 4625 may extend at a predetermined angle with respect to the axial direction A. Similarly, third section 4623 may include a top surface 4626 and a bottom surface 4627. For instance, top surface 4626 may form at least a portion of the circumferential channel. A width along the axial direction A of third section 4623 (e.g., between top surface 4626 and bottom surface 4627) may reduce along the radial direction R (e.g., from second section 4622 toward a distal end of first section 4621). Accordingly, top surface 4626 may extend at a predetermined angle with respect to the axial direction A.

Container body 110 may include or define a circumferential flange 468. For instance, at least a portion of the top of container body 110 may protrude outward along the radial direction R and extend along the circumferential direction C. Accordingly, flange 468 may have or include a bottom surface 4681 (e.g., opposite top surface 1101). Bottom surface 4681 may thus face predominantly along the axial direction A. In some instances, bottom surface 4681 may extend at a predetermined angle from the outer surface of container body 110. For example, a thickness of flange 468 (e.g., between top surface 1101 and bottom surface 4681) reduces from a proximal end thereof at container body 110 toward a distal end thereof along the radial direction R. Thus, circumferential flange 468 may be beveled, or may taper along the radial direction R.

At least a portion of cap member 123 may be beveled. For instance, cap member 123 may define a cap flange 1233. Cap flange 1233 may be defined at an outer edge of cap member 123. A top surface 1234 of cap flange 1233 may extend at a predetermined angle with respect to the axial direction A (e.g., downward or toward container body 110). For instance, top surface 1234 may correspond with bottom surface 4625 of first section 4621 of first body 462. Thus, top surface 1234 may taper outward along the radial direction R.

Second body 464 may be curved. For instance, second body 464 may have a predominantly semi-circular shape, extending along the circumferential direction C. Second body 464 may define a C shaped cross-section, taken along the circumferential direction C. It is noted that the shape of second body 464 may be substantially similar to the shape of first body 462 and as such a detailed description will be omitted for the sake of brevity, with the understanding that the description with respect to first body 462 presented above may apply to second body 464 or any subsequent bodies included in specific applications.

Flange clamp 460 may include a load shaft 470. Load shaft may connect first body 462 with second body 464. For instance, load shaft may pass through a portion of first body 462 and a portion of second body 464. In some instances, loaf shaft 470 is fixed to one of first body 462 or second body 464. Additionally or alternatively, load shaft 470 may be a threaded shaft. Flange clamp 460 may include a tightening nut or handle 472. Tightening nut 472 may be operably coupled with load shaft 470. For instance, as tightening nut 472 is rotated along load shaft 470 (e.g., along the threaded shaft), first body 462 may be pressed toward second body 464 around circumferential flange 468 and cap member 123. Due to the beveled surfaces described above, cap member 123 may be pressed toward container body 110 such that annular protrusion 125 is pressed into first sealing member 116.

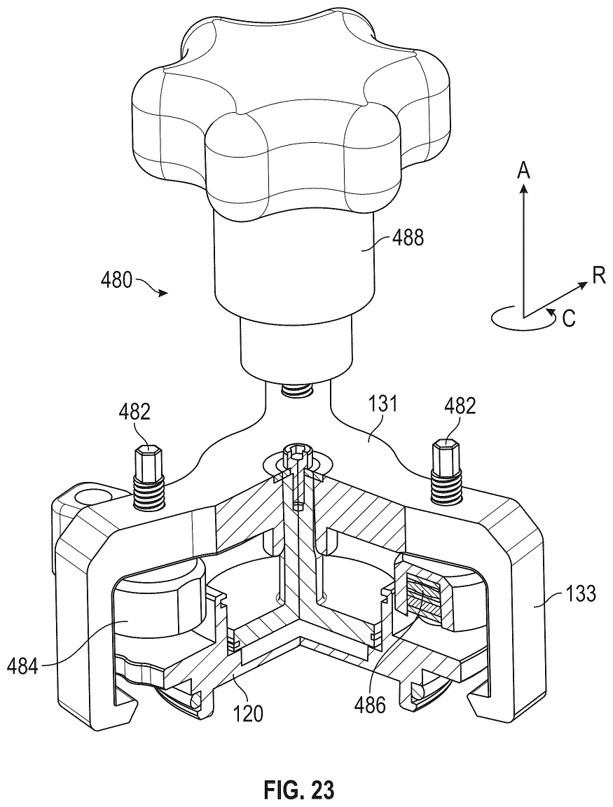

Referring briefly to FIG. 23, according to some embodiments, lid assembly 120 may include a plurality of plunger assemblies 480. For instance, the plurality of plunger assemblies 480 may be provided in addition to or alternatively to handle assembly 1301. Lid assembly 120 may include any suitable number of plunger assemblies 480. In some instances, the number of plunger assemblies 480 is equal to the number of arms 133 of claw member 131. Accordingly, each plunger assembly 480 may be associated with a respective arm 133. Hereinafter, a single plunger assembly 480 will be described in detail with the understanding that the description may apply to any suitable number of plunger assemblies 480 included in specific embodiments.

Plunger assembly 480 may include a plunger shaft 482. Plunger shaft 482 may extend predominantly along the axial direction A. For instance, plunger shaft 482 may extend or pass through arm 133 of claw member 131. Plunger shaft 482 may be positioned above at least a portion of cap member 123 of lid assembly 120 (e.g., along the axial direction A). Additionally or alternatively, plunger shaft 482 may be configured to be rotatable with respect to arm 133. Plunger shaft 482 may be a threaded shaft. Accordingly, as plunger shaft 482 is rotated, plunger shaft 482 may also translate or move along the axial direction A (e.g., with respect to arm 133).

Plunger assembly 480 may include a plunger body 484. Plunger body 484 may be attached or connected to an axial end of plunger shaft 482 (e.g., a bottom axial end). For instance, plunger body 484 may be configured to selectively contact cap member 123 (e.g., when plunger shaft 482 is rotated). Plunger body 484 may define a footprint area. For instance, the footprint area of plunger body 484 may be greater than a cross-sectional area of plunger shaft 482.

Plunger shaft 482 may be rotatable with respect to plunger body 484. For instance, plunger body 484 may include a bushing or bearing 486 therein. Accordingly, as plunger shaft 482 is rotated to press plunger body 484 into cap member 123, plunger body 484 may remain rotationally locked with respect to cap member 123. Bearing 486 may be any suitable bushing or bearing, such as a thrust bearing, a roller bearing, a sleeve bushing, or the like. Advantageously, wear between plunger body 484 and cap member 123 may be prevented.

Plunger assembly 480 may include a plunger handle or knob 488. Punger handle 488 may be coupled, attached, or otherwise connected (e.g., selectively) to plunger shaft 482. For instance, plunger handle 488 may be selectively connected to an axial end of plunger shaft 482 opposite plunger body 484 (e.g., a top axial end). plunger handle 488 may be or include any suitable type or style of handle, such as a level handle, a twist knob, a press handle, or the like. Additionally, each included plunger assembly 480 may include its own respective and dedicated plunger handle 488. Accordingly, lid assembly 120 may include multiple handles (e.g., plunger handles 488). Advantageously, a stronger, more distributed force may be applied to cap member 123 to press annular protrusion 125 into first sealing member 116.

The detailed description explains embodiments of the disclosure, together with advantages and features, by way of example with reference to the drawings.

The term “about” is intended to include the degree of error associated with measurement of the particular quantity based upon the equipment available at the time of filing the application.

It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

What is claimed is:

1. A vacuum sealable container assembly for securing and transporting extraterrestrial samples, the vacuum sealable container assembly defining an axial direction, a radial direction, and a circumferential direction, the vacuum sealable container assembly comprising:
a container body;
a lid assembly detachably coupled to the container body, the lid assembly comprising:
an input shaft extending along a first direction perpendicular to the axial direction and configured to receive a rotational input,
an output shaft extending along a second direction parallel with the axial direction and coupled to the input shaft, and
a handle member coupled to the input shaft, the handle member configured to impart a rotational force to the input shaft;
a worm shaft connected at the input shaft;
a shaft gear provided at the output shaft, the shaft gear being in geared connection with the worm shaft;
a worm gearbox operably connected between the input shaft and the worm shaft, the worm gearbox configured to provide a gear reduction between the input shaft and the worm shaft; and
a claw member threadedly coupled with the output shaft, wherein the claw member is configured to translate along the axial direction in response to a rotation of the output shaft.

2. A vacuum sealable container assembly for securing and transporting extraterrestrial samples, the vacuum sealable container assembly defining an axial direction, a radial direction, and a circumferential direction, the vacuum sealable container assembly comprising:
a container body;
a lid assembly detachably coupled to the container body, the lid assembly comprising:
an input shaft extending along a first direction perpendicular to the axial direction and configured to receive a rotational input,
an output shaft extending along a second direction parallel with the axial direction and coupled to the input shaft, and
a handle member coupled to the input shaft, the handle member configured to impart a rotational force to the input shaft;
a worm shaft connected at the input shaft; and
a shaft gear provided at the output shaft, the shaft gear being in geared connection with the worm shaft.

3. The vacuum sealable container of claim 2, further comprising:
a claw member threadedly coupled with the output shaft, wherein the claw member is configured to translate along the axial direction in response to a rotation of the output shaft.

4. The vacuum sealable container of claim 2, further comprising:
a frame fixed to the lid assembly, wherein the input shaft is supported by the frame.

5. The vacuum sealable container of claim 4, wherein the frame comprises:
a first frame member extending along the axial direction from a top of the lid assembly; and
a second frame member extending along the axial direction from the top of the lid assembly, the second frame member being spaced apart from the first frame member along the first direction.

6. The vacuum sealable container of claim 5, wherein the first frame member defines a first rotational support element and the second frame member defines a second rotational support element, and wherein the input shaft is rotatable with respect to each of the first rotational support element and the second rotational support element.

7. The vacuum sealable container of claim 5, wherein the worm shaft is positioned between the first frame member and the second frame member along the first direction.

8. The vacuum sealable container of claim 2, further comprising:
a worm gearbox operably connected with the worm shaft and the input shaft.

9. The vacuum sealable container of claim 8, wherein the worm gearbox comprises a plurality of reduction gears.

10. The vacuum sealable container of claim 2, wherein the shaft gear comprises a threaded collar, the threaded collar being in threaded connection with the worm gear.

11. The vacuum sealable container of claim 2, wherein the handle member comprises a first arm extending from the input shaft perpendicular to the first direction and a second arm extending from the input shaft perpendicular to the first direction opposite the first arm.
